(19) United States
(12) Patent Application Publication
(10) Pub. No.: US 2016/0097246 A1
(43) Pub. Date: Apr. 7, 2016

(54) PIPELINE WRENCH

(71) Applicants: Harvey B. Youngquist, JR., Ft. Meyers, FL (US); Timothy Youngquist, Ft. Myers, FL (US)

(72) Inventors: Harvey B. Youngquist, JR., Ft. Meyers, FL (US); Timothy Youngquist, Ft. Myers, FL (US)

(21) Appl. No.: 14/505,581

(22) Filed: Oct. 3, 2014

(51) Int. Cl. E21B 19/16; B25B 13/52

(52) U.S. Cl. CPC E21B 19/168; E21B 19/164; B25B 13/52

(57) ABSTRACT

Embodiments of the present invention relate to a pipeline wrench, that includes a housing which has a first end and a second end opposite the first end, a roller coupled with the housing near the first end of the housing, an idler pulley coupled with the housing, a belt between the roller and at least a portion of an opening, the belt extending beyond the first end of the housing, wherein a position of the idler pulley is adjustable such that a change in position results in a change in an amount of the belt that extends beyond the first end, and a first motor coupled with the axle of the roller, wherein operation of the first motor causes the axle to rotate.

### BACKGROUND

The present invention relates to pipes and, more particularly, to a wrench for threaded pipes.

In the field of drilling, heavy machinery is beneficial to position, connect, and drive pipeline sections of tremendous mass into a drilled well bore. In connecting pipeline sections, ordinary hand tools may not suffice for gripping the outer surface of the mobile pipe and rotating the pipe to secure a threaded connection between the mobile section and a stationary section in the well bore.

Wrenches that grip or clamp the pipe with jaws prior to rotation are known. The jaws are rotated with the pipe, and then the jaws are released, rotated to the original position, and the process repeated. U.S. Pat. No. 7,707,914 discloses a wrench in which three rollers replace the jaws. The rollers are forced against the pipe at about equal distances around the pipe circumference. One or more rollers are power rotated to rotate the pipe while held clamped between the rollers. The contact area between each roller and the pipe is limited to a single tangential line. U.S. Pat. No. 5,150,638 discloses a clamping method that includes a belt, mounted on a rotatable head, that wraps around the pipe. The entire head then rotates to rotate the pipe. This purportedly improves the grip on the pipe, but requires repeated grip and release operation.

### SUMMARY

Embodiments of the present invention relate to a pipeline wrench, that includes a housing which has a first end and a second end opposite the first end, a roller coupled with the housing near the first end of the housing, an idler pulley coupled with the housing, a belt between the roller and at least a portion of an opening, the belt extending beyond the first end of the housing, wherein a position of the idler pulley is adjustable such that a change in position results in a change in an amount of the belt that extends beyond the first end, and a first motor coupled with the axle of the roller, wherein operation of the first motor causes the axle to rotate.

Other embodiments of the present invention relate to a pipeline wrench, including a housing having with a first end and a second end opposite the first end, the first end is forked to form an opening and comprises a right extension and a left extension, a first toothed-roller connected with the housing at the right extension of the first end of the housing, a second toothed-roller connected with the housing at the left extension of the first end of the housing, a track within the housing running lengthwise with the housing, an idler pulley wherein a portion of the idler pulley lies within the track, a first motor and piston connected to the idler pulley for positioning the idler pulley within the track, a toothed belt extending beyond the first end of the housing, located between each of the respective rollers and a portion of the opening and located between the idler pulley and the second end, wherein the teeth of the belt are configured to interlock with the teeth of the first and second rollers, a lifting arm connected to the housing, a respective second motor coupled to each axle of the first and second toothed-rollers, and a snubbing line connected to the second end of the housing.

Another embodiment of the present invention relates to a method of rotating a pipe section having a first end in contact with a second end of a stationary pipe section, the method comprising: positioning a first portion of a belt around an outside of the first pipe section, wherein a second portion of the belt is coupled with a wrench housing and the first portion extends beyond a first end of the wrench housing by an adjustable amount, locating the second portion of the belt to vary the adjustable amount such that the first pipe section contacts the first end of the housing and is frictionally engaged with the first portion of the belt, and moving the belt whereby the frictional engagement of the first portion of the belt and the first pipe section causes the first pipe section to rotate.

### BRIEF DESCRIPTION OF THE DRAWINGS

Various aspects of embodiments of the disclosure are illustrated by way of example, and not by way of limitation, in the accompanying drawings, wherein:

FIG. 1 illustrates a side view of a pipeline wrench in accordance with the principles of the present invention.

FIG. 2 illustrates another view of the wrench of FIG. 1.

FIG. 3 illustrates a top-down view of the wrench of FIG. 1.

FIG. 4 illustrates a view of the interaction between teeth of the roller and teeth of the belt.

FIG. 5 illustrates a top-down view of the wrench of FIG. 1.

FIG. 6 illustrates a top-down view of a wrench in accordance with the principles of the present invention wherein an idler pulley may be positioned at the end of a track closest to a belt, and the idler pulley can driven by a motor.

FIG. 7 illustrates the wrench of FIG. 6 wherein the idler pulley is positioned at the end of the track furthest from the belt.

FIG. 8 illustrates the wrench of FIG. 1 anchored by a snubbing cable with the attachment of a strain gauge.

### DETAILED DESCRIPTION

The detailed description set forth below in connection with the appended drawings is intended as a description of various embodiments of the invention and is not intended to represent the only embodiments in which the invention may be practiced. The detailed description includes specific details for the purpose of providing a thorough understanding of the invention. However, it will be apparent to those skilled in the art that the invention may be practiced without these specific details. In some instances, well known structures and components are shown in block diagram form in order to avoid obscuring the concepts of the invention.

Embodiments of the present invention relate generally to a pipeline wrench that may stabilize, grip, and rotate a threaded fluid pipeline section in a common axis with a threaded stationary pipeline section, thereby connecting or removing the sections for assembly or disassembly of a fluid pipeline. For purposes of the present disclosure, references to the singular such as “a,” “an,” or “the” also refer to the plural form. Furthermore, the term “coupled” does not exclude the presence of intermediate elements between the coupled items. Any examples given herein in list form are meant to be illustrative and not exclusive.

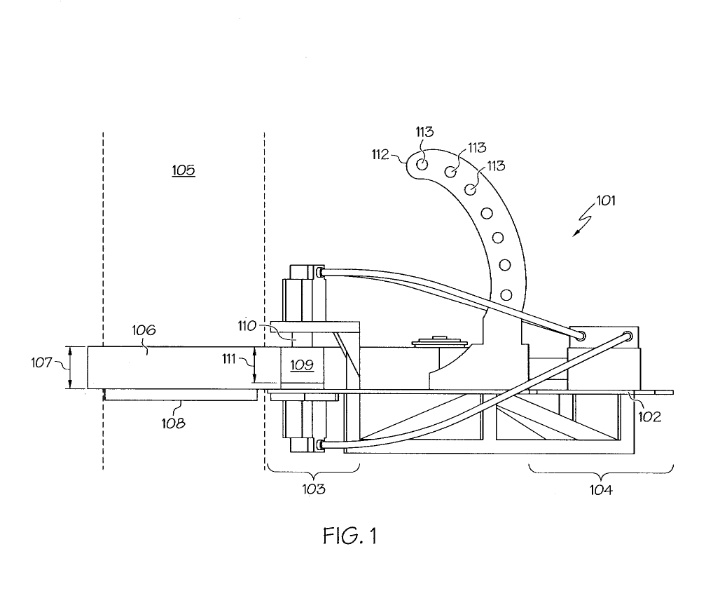

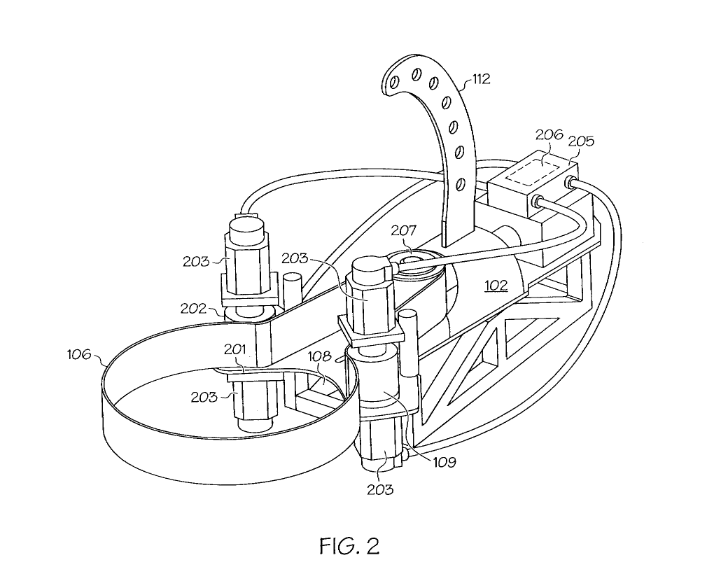

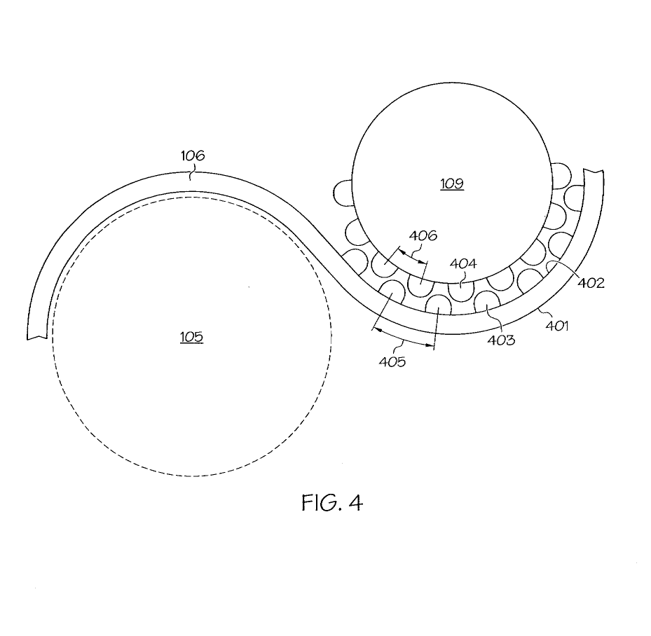

FIG. 1 shows an example of an embodiment of the pipeline wrench. In this example, the length of a housing 102 appears larger than the width. However, other shapes of the housing 102 are possible without departing from the spirit and scope of the invention. A belt 106 of a wrench 101 having a width 107 may be wrapped around a pipe or pipeline section 105. The wrench 101 can include the housing 102 with a first end 103 and a second end 104 opposite the first end 103. A roller 109 having a length 111 may be positioned near the first end 103 of the housing 102. The roller 109 is positioned near the first end 103 of the housing 102 when the roller 109 is located between the belt 106 and an idler pulley 207 (illustrated in FIG. 2). Other rollers may be present, but not visible in this illustration. The positioning of the roller 109 may be sufficient to keep tension with the belt 106 regardless of the diameter of the pipeline section 105 and may drive the belt 106 through interaction of one or more teeth (illustrated in FIG. 4). For example, the roller 109 may overhang the first end 103 of the housing 102. The roller 109 may overhang an opening 108 where the pipeline section 105 can be located. Alternatively, the roller 109 may be completely contained within the housing 102. When tightened around the pipeline section 105, the belt 106 may also contact the roller 109. The axle 110 of the roller may be coupled with the first end 103 of the housing 102 of the wrench 101. In operation, the pipeline wrench 101 can be hung over the head of a well bore by a suspension cable from a crane, drilling rig, or other weight bearing equipment (not illustrated). The pipeline wrench 101 may be coupled with the suspension cable via a lifting arm 112. Alternatively, the wrench 101 may be secured by connecting the cable to any part of the housing 102 capable of bearing the weight of the wrench.

The lifting arm 112 of the housing 102 of the pipeline wrench 101 may be attached to the housing 102 and may extend away from the housing 102. The lifting arm 112 may be attached in a manner such that the attachment of the lifting arm 112 and the housing 102 may withstand suspension of the wrench 101 by the lifting arm 112. Examples may include a weld, a pin, a bolt, or a screw attaching the lifting arm 112 to the housing 102. Alternatively the lifting arm 112 and the housing 102 may be integrally formed. The weight bearing lifting arm 112 may be securely coupled with the housing 102 for suspending the pipeline wrench 101 from a cable (not illustrated). Multiple through holes 113 are contemplated down the slight curvature of the lifting arm 112. These holes 113 may allow fastening to the cable of the crane to alter the balance and level of the suspended pipeline wrench 101. The curved shape of the lifting arm 112 as illustrated is exemplary only. The lifting arm 112 of the wrench 101 may comprise any shape capable of withstanding the weight of the wrench 101 hanging in suspension from the lifting arm 112.

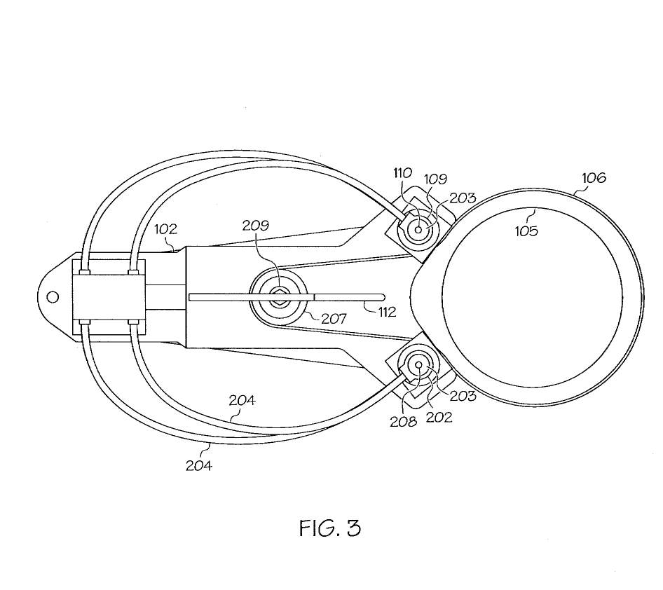

FIG. 2 illustrates the wrench of FIG. 1 from a different viewpoint. The pipe is removed in this illustration so as not to obscure an edge 201 of the opening 108 of the housing 102. In one embodiment, the first end 103 of the wrench 101 may be forked to form the opening 108. Two rollers 109 and 202 may be present at the first end 103 of the wrench 101. In fact, any number of rollers sufficient for guiding or driving the belt 106 may be used. Each roller 109 and 202 may be positioned on opposite sides of the opening 108. Respective portions of the belt 106 may be positioned between each respective roller 109 and 202 and a portion of the opening 108. In this arrangement, a portion of the belt 106 may overhang the first end 103 of the housing 102 in the formation of a loop that may be fitted around the pipe 105. Another portion of the belt 106 may be positioned between the idler pulley 207 and the second end 104 of the housing 102. The belt 106 may be tightened by location of the idler pulley 207 farther away from the opening 108 on a track 302 (as shown in FIG. 3). Furthermore, a guide 210 may be coupled with the roller 109 to keep the belt 106 engaged with the roller 109 by locating the belt 106 between the guide 210 and the roller 109. Each roller 109 and 202 may have a respective guide. The edge 201 may rest against the pipe 105 when the belt 106 is tightened against the pipe 105. Furthermore, the belt 106 may be tightened against the rollers 109 and 202. Once the belt 106 is snugly tightened against the surface of the pipe 105, rollers 109 and 202 may drive the belt 106 in a clockwise or counterclockwise direction for connection or removal of the pipe 105 to a stationary section of pipeline. For right-hand-threaded pipeline sections, driving clockwise secures the connection between the pipeline sections, and driving counterclockwise releases the connection between pipeline sections.

Each of a plurality of motors 203 may be coupled with one of the rollers 109 and 202. One of ordinary skill in the art would recognize that driving the belt 106 may be accomplished by a single motor 203 that may be coupled with either roller 109 or 202. However, many arrangements and locations of motors 203 may be sufficient to drive the belt 106 through the rollers 109 and 202. Such embodiments may include a single motor 203 coupled with both rollers 109 and 202, two motors 203 coupled with rollers 109 and 202, or a single motor 203 coupled with either roller 109 or 202. The motors 203 may be connected to hydraulic, pneumatic, or electric lines 204 (as shown in FIG. 3).

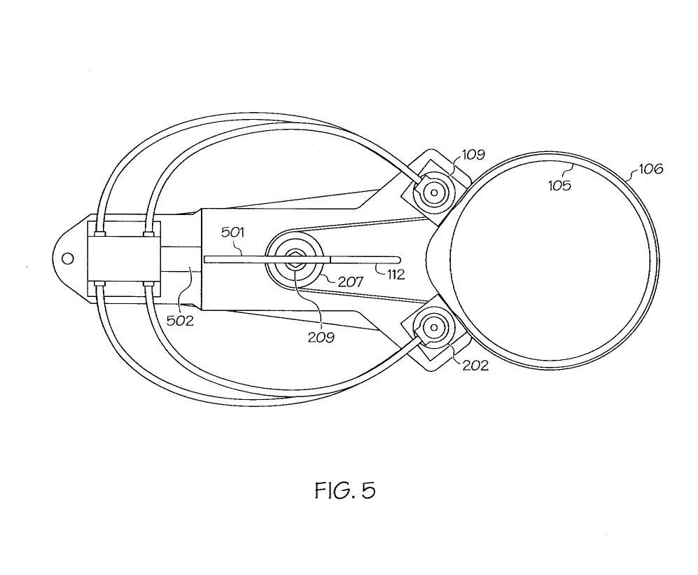

The lines 204 may be connected to a power supply 205. The power supply 205 may provide fluid pressure or electric current to the lines 204 and the motors 203. Optionally, the power supply 205 may contain a controller 206 on any face of the power supply 205. The controller 206, for example, may comprise a joystick for controlling the fluid pressure or electric current to the motors 203 or piston (as shown in FIG. 5). One of ordinary skill will recognize that additional manually manipulated controllers, other than joysticks, are contemplated within the scope of the present invention. The controller 206 may alternatively comprise a connector that can be coupled with remotely located controllers as well.

FIG. 3 illustrates a top down view of the wrench 101. This view illustrates the opening 108 and the belt 106. Pipeline sections are typically two inches to 20 inches in diameter. However, lengths for the belt 106 that support use with pipeline sections up to 36 inches in diameter and above are contemplated. The pipeline wrench 101 may typically weigh 700 pounds. In order to drive pipeline sections, the wrench 101 may supply ten foot-pounds to over 20,000 foot-pounds of torque to a section (e.g. pipe 105) of pipeline. The wrench 101 may rotate the pipeline section at 100 rotations per minute (rpm). The typical speed of rotation for a six inch diameter pipeline section may, for example, be about 60 rpm. Smaller diameter pipeline will necessarily rotate faster at the same transverse speed of the belt 106. The material of the pipeline section for use with the wrench 101 is typically fiberglass or is encased in fiberglass. However, the pipeline wrench 101 may be used with pipeline sections of any material capable of withstanding the pressure and environment of an oil, gas, water, argon, or other fluid well pipeline. Some examples of such materials may include polyvinylchloride, copper, steel, and aluminum.

FIG. 4 depicts a view of the interaction of the belt 106 and the roller 109. The belt 106 may be a V-belt for enhanced interaction with rollers 109 and 202. The width 107 of the belt 106 may be, for example, between four to six inches based on the desired surface area against the pipeline section 105. However, a width 107 of the belt 106 may be larger or smaller based on the desired frictional fit to the pipe 105. While an inside surface 401 of the belt 106 may be substantially smooth to protect the surface of the pipe 105, etched patterns are also contemplated to enhance gripping the surface of the pipe 105 such as, for example, when used in lubricatious conditions. An outside surface 402 of the belt 106 may include drive teeth 403. The belt teeth 403 may span the width 107 of the belt 106. In one embodiment, the pitch 405 is 8 mm, the pitch length is 1000 mm, and the width is 21 mm, wherein “pitch” defines the distance from the center of one tooth the center of a neighboring tooth within the belt teeth 403 and the pitch length defines the circumference of the belt 106. A person skilled in the art would know to choose the pitch, depth, width, and length of teeth and pitch length of the belt based on interaction of the belt teeth 403 with the roller teeth 404, if present. One of ordinary skill would also recognize that the belt may be a chain, rope, or other continuous material capable of being frictionally fit to and turning the pipe 105.

The outside of the rollers 109 and 202 may include teeth 404. One example of dimensions for the teeth 404 may be 8 mm pitch 406. The pitch 406 of the roller teeth 404 may be the same as the pitch 405 of the belt teeth 403. However, the pitches 405 and 406 may differ based on desired interaction between the sets of teeth 403 and 404. Another example of the pitch 406 may be 3 mm. One of ordinary skill would know to select the depth, pitch, width, and length of the roller teeth 404 based on desired interaction with the belt teeth 403.

The material of the belt 106 can be selected to withstand high torque during the positioning of the pipeline section, high temperature and friction, and may be resistant to degradation when oil or gas contacts the belt 106. Examples of suitable materials include urethane, polyurethane, or any other elastomer compounds exhibiting these qualities. However, the belt 106 may be comprised of multiple materials. Such as, for example, including a carbon fiber layer in the elastomer belt 106 for support. Another contemplated example is to include a nylon or neoprene coating that may protect the elastomer against oil or grease exposure.

The rollers 109 and 202 may be composed of mild steel, aluminum, or any other material suitable for driving the belt 106 without damaging the belt 106. The length 111 of the roller 109 may be wider than the width 107 of the belt 106. For example, five inch long rollers 109 and 202 could be used if the belt 106 was, for example, four inches in width 107. The width 107 of the belt 106 does not have to be varied based on the diameter of the pipe 105. However, the width 107 of the belt 106 may be varied. In one embodiment as shown in FIG. 3, there can be two toothed-rollers 109 and 202 and the idler pulley 207. The toothed-rollers 109 and 202 may be seated at the end of the housing 102 from which the belt 106 extends. In fact, the teeth 403 of the belt 106 may interlock with the teeth 404 of the rollers 109 and 202. Therefore, the size and pitch of the teeth 403 of the belt 106 can be substantially the same size and pitch of the teeth 404 of the rollers 109 and 202. Thereby, rotation of the rollers 109 and 202 may cause rotation of the belt 106 via friction or the driving of interlocking sets of teeth 403 and 404.

The rotation of each of the toothed-rollers 109 and 202 may be driven by a respective motor 203. In one embodiment of the pipeline wrench, the motor 203 may be a hydraulic motor 203. However, other embodiments can include pneumatic motors (not illustrated) or electric motors (not illustrated) to drive the rotation of the rollers 109 and 202. In another example, two hydraulic motors 203 are seated on opposite sides of each of the toothed-rollers 109 and 202 on the same axle 110 and 208 as the rollers 109 and 203. In this example, hydraulic pressure is supplied by one or more respective hydraulic lines 204 connecting each of the four hydraulic motors 203 to the power supply 205 attached near the second end 104 of the housing 102. An accumulator valve (not illustrated) may be used to prevent pressure loss in the lines 204 to the hydraulic motors 203. The motors 203 can be regulated by supplying substantially equal pressure to each of the four hydraulic motors 203. This causes the rollers 109 and 202 to operate at substantially similar speeds. Of course, embodiments of the wrench 101 using more than four or less than four motors is contemplated.

FIG. 5 illustrates the wrench of FIG. 1 with the idler pulley 207 that may have at least a portion of the idler pulley 207 overlaying a sliding track 501. The idler pulley 207 may not necessarily contain teeth on its surface that contacts the belt 106. The idler pulley 207 may be positioned so that an axle 209 of the idler pulley 207 may extend into and slide along the track 501 that can extend along the length of the housing 102. Alternatively, the idler pulley 207 can enter the track 501. The track 501 may be positioned between and extending away from the toothed rollers 109 and 202 such that the idler pulley 207 may be substantially equidistant from the toothed rollers 109 and 202 at any point along the track 501. The length of the track 501 and piston assembly 502 may allow movement of the idler pulley 207 of about five to fifteen inches. The belt 106 may be in contact with part of the circumference of the toothed-rollers 109 and 202 at the interior of the housing 102 and with an outer circumference of the idler pulley 207 opposite rollers 109 and 202 as shown in FIG. 2 and FIG. 3. The idler pulley 207, by altering positioning along the track 501, may tighten or loosen the belt 106 around the outer surface of the pipeline section 105.

The idler pulley 207 may be coupled with a piston assembly 502 that may have a mobile and a stationary portion. The piston assembly 502 may be coupled with the power supply 205. In one embodiment, the piston assembly 502 may be manually adjusted, such as, for example, using a threaded rod and nut, a come-along, or similar device. In one embodiment, the power supply 205 may supply fluid or electric current to the piston 502. The stationary portion of the piston assembly 502 may be coupled with the housing 102 and the mobile portion of the piston assembly 502 coupled with the idler pulley 207. The power supply 205, by altering fluid pressure or electric current, may alter the effective length of the piston 502 and therefore the position of the mobile portion of the piston assembly 502. In turn, the position of the mobile portion of the piston assembly 502 may alter the position of the idler pulley 207 along the track 501 due to the coupling of the idler pulley 207 and the mobile portion of the piston 502.

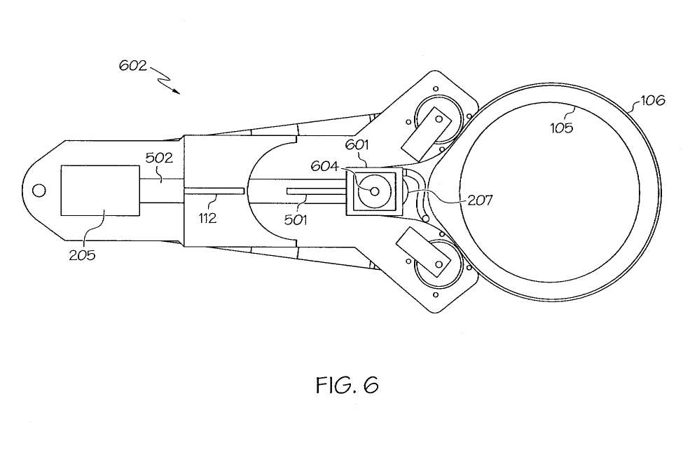

FIG. 6 illustrates an embodiment of a wrench 602 with a motor 601 coupled with the idler pulley 207. Additionally, the idler pulley 207 is illustrated in the position closest to the first end 103 of the wrench 602. In this position, the belt 106 may be positioned for a largest diameter of pipe 105. Furthermore, the idler pulley 207 may have teeth to drive the belt 106. Motor(s) 203 may be present but not visible.

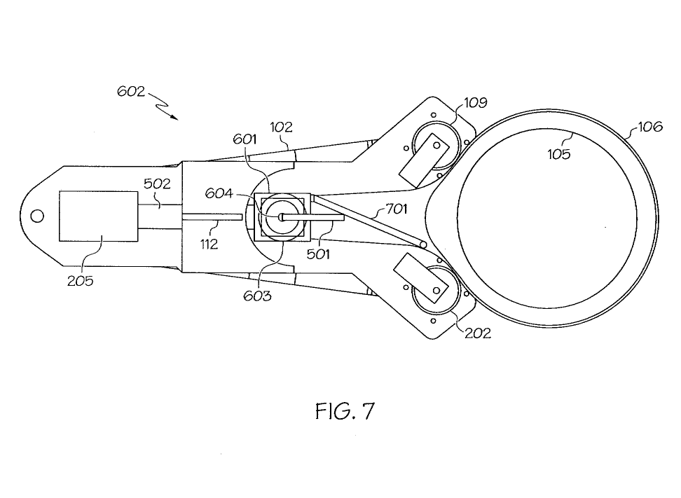

FIG. 7 illustrates the wrench of FIG. 6 with the idler pulley 207 in the position furthest from the first end 103 of the wrench 602. In this position, the belt 106 may be positioned for a smallest diameter of pipe 105. Also, a line 701, attached to the power supply 205, can supply power to the motor 601. The motor 601 may be hydraulic, pneumatic, or electric.

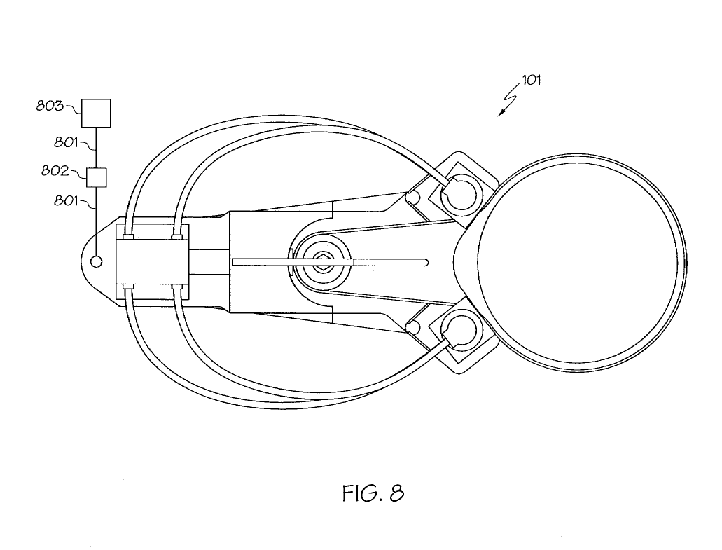

FIG. 8 illustrates the wrench 101 of FIG. 1 with a snubbing line 801 attached near the second end 104 of the housing 102. The snubbing line 801 may be a structure capable of resisting the strain caused by rotating the belt 106 frictionally fit to the pipe 105. The snubbing line 801 may be attached near the housing 102 in a position sufficient to resist strain caused by rotating the belt 106 frictionally fit to the pipe 105. Because the wrench 101 may act as a lever, attachment of the snubbing line near the second end 104 of the housing 102 may reduce strain on the snubbing line 801. Attaching the snubbing line 801 near the second end 104 accomplishes these goals. The snubbing line 801 attached near the second end 104 means the snubbing line may be attached to the housing 102 between the power supply 205 and the second end 104 of the housing 102. This line 801 may also be attached to a secure structure 803 to prevent the wrench 101 from turning during operation. Alternatively, the snubbing line 801 may be attached to any location of the housing 102 sufficient to withstand operating strain. Secure structures 803 may be immobile structures or structures with sufficient mass to resist the turning of the wrench 101 while in use. Examples may include an in-ground pole, a building, a truck, a crane, or the like. A strain gauge 802 may be attached between two or more snubbing lines 801 attached to the wrench 101 and the secure structure 803 to measure the torque applied to the pipeline. In addition to a strain gauge 802, other sensors are contemplated such as a torque or pressure sensor, for example. This measurement may be useful to prevent overtightening or damage to the wrench 101 or pipeline section 105.

What is claimed is:

1. A pipeline wrench, comprising:
a housing comprising a first end and a second end opposite the first end, wherein
a portion of the first end is adjacent an opening configured to accept a section of pipe;
a roller, comprising an axle, coupled with the housing near the first end of the housing;
an idler pulley coupled with the housing;
a belt between the roller and at least a portion of an opening, the belt extending beyond the first end of the housing, wherein a position of the idler pulley is adjustable such that a change in position results in a change in an amount of the belt that extends beyond the first end; and
a first motor coupled with the axle of the roller, wherein operation of the first motor causes the roller to rotate.

2. The pipeline wrench of claim 1, comprising:
a lengthwise track that is substantially parallel with the major axis of the housing, wherein a portion of the idler pulley overlies the lengthwise track.

3. The pipeline of claim 1, wherein
the belt comprises a first set of teeth on an outside of the belt and the roller comprises a second set of teeth on an outside of the roller, wherein the teeth in each set are spaced so that at least one tooth of the first set and at least one tooth of the second set interact when either the roller or the belt moves.

4. The pipeline wrench of claim 1, comprising:
a moveable piston coupled with the idler pulley.

5. The pipeline wrench of claim 4, comprising:
a power supply coupled with the piston.

6. The pipeline wrench of claim 5, wherein
the power supply comprises an electric motor, a hydraulic motor, a pneumatic motor, a hydraulic pump, or a pneumatic pump.

7. The pipeline wrench of claim 1, comprising:
a second motor coupled with the idler pulley.

8. The pipeline wrench of claim 7, wherein
the second motor comprises an electric motor, a hydraulic motor, or a pneumatic motor.

9. The pipeline wrench of claim 1, comprising:
a lifting arm, having a length, coupled with the housing and the length of the lifting arm comprises a through hole.

10. The pipeline wrench of claim 1, comprising:
a snubbing line attached near the second end of the housing.

11. The pipeline wrench of claim 10, wherein
the snubbing line comprises a strain gauge.

12. The pipeline wrench of claim 1, wherein
the belt is endless.

13. The pipeline wrench of claim 1, wherein
the first motor is a hydraulic, a pneumatic, or an electric motor.

14. A pipeline wrench, comprising:
a housing having with a first end and a second end opposite the first end;
the first end is forked to form an opening and comprises a right extension and a left extension;
a first toothed-roller connected with the housing at the right extension of the first end of the housing;
a second toothed-roller connected with the housing at the left extension of the first end of the housing;
a track within the housing running lengthwise with the housing;
an idler pulley wherein a portion of the idler pulley lies within the track;
a first motor and piston connected to the idler pulley for positioning the idler pulley within the track;
a toothed belt extending beyond the first end of the housing, located between each of the respective rollers and a portion of the opening and located between the idler pulley and the second end, wherein the teeth of the belt are configured to interlock with the teeth of the first and second rollers;
a lifting arm connected to the housing;
a respective second motor coupled to each axle of the first and second toothed-rollers; and
a snubbing line connected to the second end of the housing.

15. A method of rotating a pipe section having a first end in contact with a second end of a stationary pipe section, the method comprising:
positioning a first portion of a belt around an outside of the first pipe section, wherein a second portion of the belt is coupled with a wrench housing and the first portion extends beyond a first end of the wrench housing by an adjustable amount;
locating the second portion of the belt to vary the adjustable amount such that the first pipe section contacts the first end of the housing and is frictionally engaged with the first portion of the belt; and
moving the belt whereby the frictional engagement of the first portion of the belt and the first pipe section causes the first pipe section to rotate.

16. The method of claim 15, comprising:
anchoring the wrench housing to a weight bearing equipment.

17. The method of claim 15, comprising:
securing the wrench housing to a secure structure.

18. The method of claim 17, comprising:
measuring strain caused by securing the wrench housing to a secure structure.

19. The method of claim 15, wherein locating further comprises:
coupling an idler pulley to the second portion of the belt;
coupling a piston assembly to the idler pulley; and
expanding and contracting the piston assembly to change a location of the second portion of the belt.

20. The method of claim 15, wherein moving further comprises:
coupling a third portion of the belt with a motor; and
rotating the motor to effect movement of the belt.
